(19) United States
(12) Patent Application Publication
(10) Pub. No.: US 2008/0016204 A1
(43) Pub. Date: Jan. 17, 2008

(54) ZigBee network module system

(75) Inventors: Yen-Hung Lai, Taipei (TW); Sung Kang-Hua, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 11/896,862

(22) Filed: Sep. 6, 2007

(30) Foreign Application Priority Data
Jun. 9, 2006 (TW) 095132873

(51) Int. Cl. G06F 15/173

(52) U.S. Cl. 709/223

(57) ABSTRACT

The invention discloses a ZigBee network module which adds a ZigBee application programming interface (API) unit in an application layer of the original ZigBee communication protocol. The ZigBee network module comprises a network management API, a data transmission API, and essential parameters of ZigBee functions. The network management API comprises a plurality of functional instructions for executing ZigBee network related functions. The data transmission API is used for transmitting data corresponding to the functional instructions. Accordingly, when a developer wants to change a structure or a function, the developer only needs to update instructions or parameters of the ZigBee API unit without the need to understand function codes of the ZigBee network stack and how the ZigBee network works, such that the ZigBee network module can be developed easily.

### BACKGROUND OF THE INVENTION

1. Field of the Invention

The invention relates to a network system structure and more particularly to a ZigBee network module system.

2. Description of the Prior Art

ZigBee is a wireless network technology capable of short range, low power, and low cost. As shown in FIG. 1, the ZigBee network structure comprises a physical layer 11, a media access control layer 12, a network layer 13, a ZigBee application layer 14, and a security layer 15 for preventing from leaking beacons. The physical layer 11 and the media access control layer 12 in the low level are the bases of protocols of the ZigBee application layer 14 and the network layer 13, and these layers 11˜14 are regulated by IEEE802.15.4 group. The layers above the network layer 13 are defined by ZigBee alliance. IEEE802.15.4 specification regulates a wireless technology with a low data transmission rate (<250 Kbs) and transmission frequency at 2.4 GHz and 868/928 MHz. The wireless technology is suitable for the personal area network and peer-to-peer mesh network.

ZigBee application layer 14 comprises an application support sublayer (APS) 141, a ZigBee device object (ZDO) 142, and an application framework (AF). The AF comprises a plurality of application objects 143 defined by end manufactures. The APS 141 is equal to an interface between the network layer 13 and the application layer 14. The APS 141 provides the binding table between objects and transmits messages between connected devices. The ZDO 142 is capable of initializing the APS 141, constructing information required by its upper layer, transmitting and responding linking requests, discovering devices and application services in the same network, and establishing a security relation among the devices in the same network.

According to the aforesaid network stack, when a developer wants to change one of the functions, the developer needs to find out function codes in each layer related to the function according to a definition of the function in a function manual. Then, the developer changes or updates the function codes one by one. Accordingly, it takes time, and it is not convenient for developers.

### SUMMARY OF THE INVENTION

The scope of the invention is to provide a ZigBee network module system, which is easily developed for developers.

The ZigBee network module system comprises a network stack and an application layer. The network- stack comprises a physical layer, a media access control layer, and a network layer. The network stack and the application layer are defined as the ZigBee module. There are two development modes for the ZigBee module.

The user application program is written into the application layer. The application layer comprises an application framework (AF), a ZigBee device object (ZDO), an application support sublayer (APS), and a ZigBee application programming interface (API) unit.

The AF comprises a plurality of application objects. The ZDO is capable of initializing the APS, constructing information, transmitting and responding linking requests, discovering devices and application services in the same network, and. establishing a security relation among devices in the network. The APS is used for receiving instructions of the network management API and connecting to a corresponding layer in the network stack.

The invention is characterized by a ZigBee API unit disposed on the AF and the ZDO by the application layer, and the ZigBee API unit comprises a network management API and a data transmission API. The network management API has a plurality of functional instructions for executing ZigBee network functions. The data transmission API is used for transmitting data corresponding to the functional instructions.

The aforesaid development mode embeds a user application program in the ZigBee module. The other mode reserves an original application, and the system further comprises an external CPU connected to the ZigBee module. The user application program is embedded in the CPU.

### BRIEF DESCRIPTION OF THE APPENDED DRAWINGS

FIG. 1 is a schematic diagram illustrating a conventional ZigBee network structure.

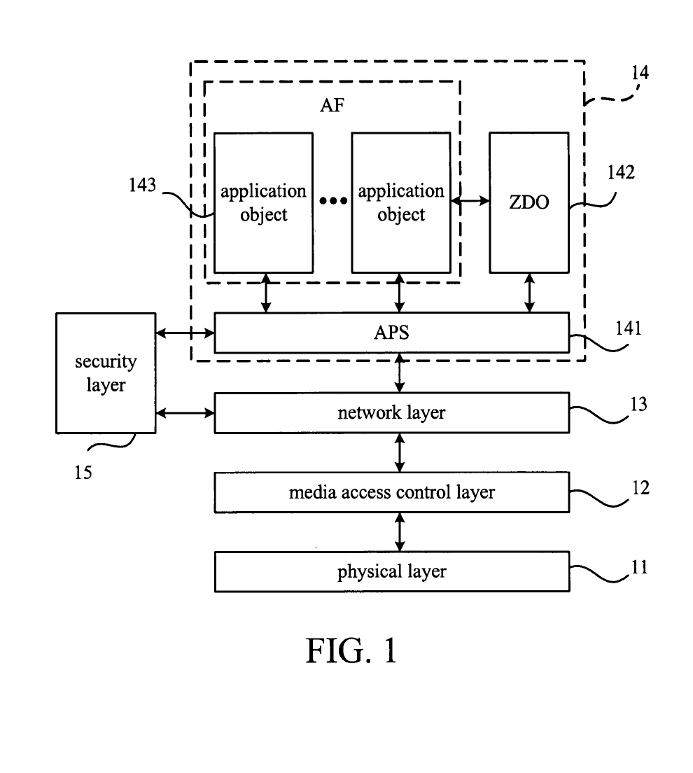

FIG. 2 is a schematic diagram illustrating a system structure of a ZigBee network module system according to a first embodiment of the invention.

FIG. 3 shows a flow chart of joining a network via the ZigBee network module of the invention.

FIG. 4 is a schematic diagram illustrating a system structure of a ZigBee network module system according to a second embodiment of the invention.

### DETAILED DESCRIPTION OF THE INVENTION

The advantage and spirit of the invention may be understood by the following recitations together with the appended drawings.

It should be noticed that similar objects are assigned to the same number in the following description.

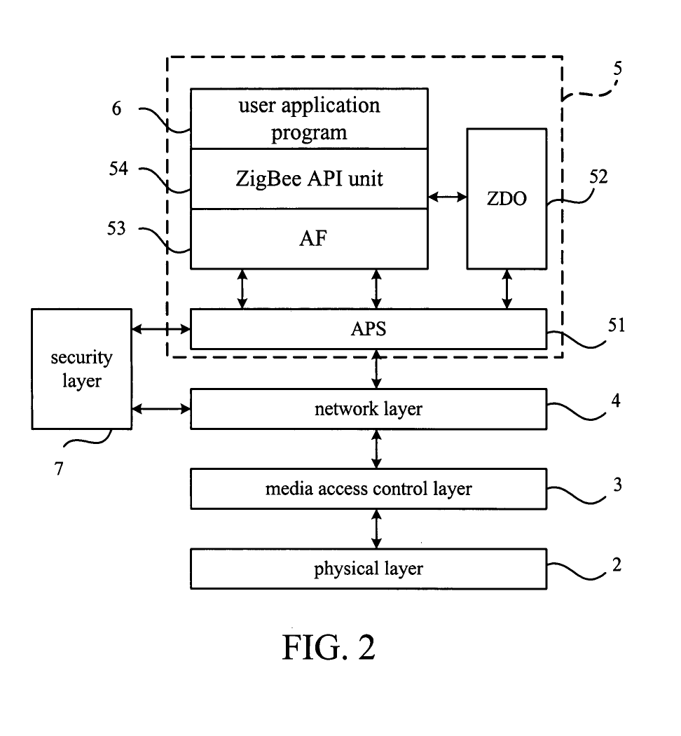

Please refer to FIG. 2. According to the first preferred embodiment of the invention, the ZigBee network module system comprises a physical layer 2, a media access control layer 3, a network layer 4, an application layer 5, and a security layer 7. A user application program is written in the application layer 5. The physical layer 1, the media access control layer 3, and the network layer 4 are defined as a network stack. The network stack is called by the application layer 5 to execute a related network function. In the following description, the network stack and the application layer 5 are defined as a ZigBee module.

In this embodiment, the development mode is that a user application program 6 is embedded in the ZigBee module.

The physical layer 2 is used for starting and stopping a wireless transmitter/receiver, selecting channels, and transmitting and receiving packets. The media access control layer 3 is used for managing beacons, accessing channels, managing guaranteed time slots (GTS), authenticating frames and replaying transmission, combination, and division of the packets. The network layer 4 comprises a mechanism of joining and leaving a network, a mechanism of frame security, and a mechanism of transmitting frames to a destination. The security layer 7 is used to avoid leaking beacons.

The application layer 5 comprises an application support sublayer (APS) 51, a ZigBee device object (ZDO) 52, an application framework (AF) 53, and a middle layer. The AF 53 has a plurality of application objects defined by end manufactures. The middle layer, alternatively, the ZigBee API unit 54 disposed on the AF 53 and the ZDO 52 is suitable for development by users.

The APS 51 is used for receiving instructions of the network management API and for connecting to a corresponding layer in the network stack. The ZDO 52 is capable of initializing the APS 51, constructing information, transmitting and receiving linking requests, discovering devices and application services in the same network, and establishing a security relation among the devices in the network.

The ZigBee API 54 comprises a series of APIs and essential parameters for developers. The series of APIs mainly are a network management API and a data transmission API. A user utilizes the network management API to write an application object, and the network management API comprises multiple functional instructions for executing ZigBee network functions. The functional instructions comprise a starting request instruction for starting a network, a scanning request instruction for scanning a network, a joining request instruction for joining a network, a leaving request instruction for enforcing a device leaving a network, an auto-searching request instruction for searching whether there is a connectable device of a network capable of providing related services, a linking instruction for a network device executing a linking function, an authenticating instruction for authenticating a user, and a selecting instruction for selecting a network. The data transmission API is used for transmitting data corresponding to the functional instructions, and it comprises a receiving instruction for receiving data and a transmitting instruction for transmitting data.

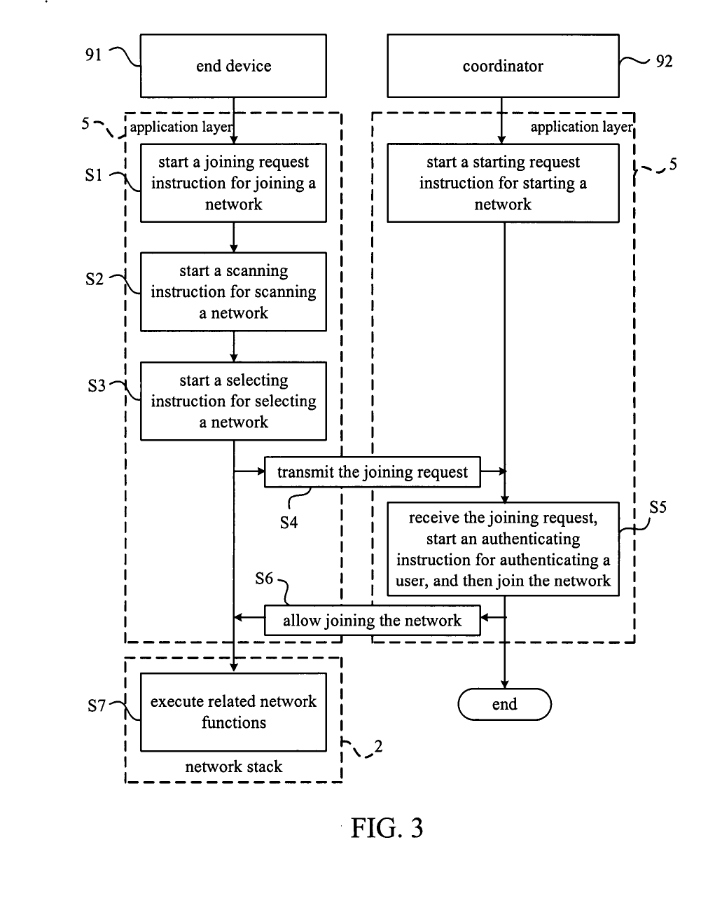

In practical operations, as shown in FIG. 3, when an end device 91 wants to join a network, at first, the step S1 is performed to utilize the network management API of the application layer 5 to start a joining request instruction for joining a network. Next, the step S2 is performed to start a scanning network instruction for scanning a network. Afterward, the step S3 is performed to start a selecting instruction for selecting a suitable personal area network (PAN). Finally, the step S4 is performed to transmit a joining request to a coordinator 92.

The coordinator 92 utilizes the network management API of the application layer 5 to start a starting request instruction before receiving a selecting instruction. When the coordinator 92 receives a joining request transmitted by a terminal device 91, the step S5 is performed to start an authenticating instruction of the application layer 5 for authenticating a user. The step S6 is then performed to notify a user being allowed to join the network. When the terminal device 91 of the user receives the notification, the step S7 is performed to execute the related network functions via the APS 51.

Accordingly, a developer only needs to understand the ZigBee API unit 54, and then the developer can control the ZigBee terminal device without the need to understand the function codes of the ZigBee network stack and how the ZigBee network works.

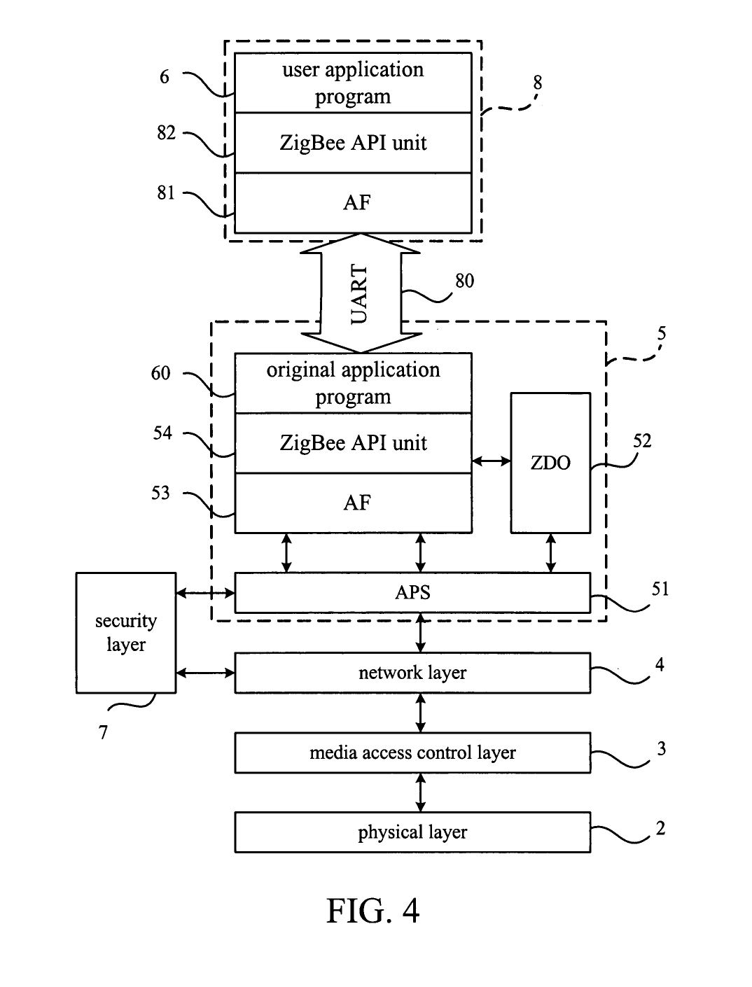

As shown in FIG. 4, the second embodiment of the invention provides the other development mode. The development mode reserves the original application 60. The system further comprises an external CPU 8 connected to the ZigBee module, and the user application program 6 is embedded in the CPU 8.

The CPU 8 connects to the ZigBee module via an interface such as a universal asynchronous receiver/transmitter (UART), an inter-integrated circuit (12C), or the like. The CPU 8 further has a firmware 81 and a user API 82. The user API 82 corresponds to the ZigBee API unit 54. When the user API 82 is called, the firmware 81 generates information which is to be transmitted to the ZigBee APU unit 54. Afterward, the ZigBee API unit 54 transforms the information into an interface capable of calling a corresponding layer in the network stack, so as to start the ZigBee module.

According to the second embodiment, because the user application program 6 is embedded in the CPU 8, the developer can keep the original application 60 and the structure is flexible as well. When the structure is changed, the user application program 6 is embedded in the new development hardware without modifying the original application program 60.

Accordingly, the ZigBee network module system of the invention has a ZigBee API unit 54 in the ZigBee module. And, the ZigBee API unit 54 has a series of APIs and essential parameters for developers. Then, a developer can change a structure or a function without the need to understand the function codes of the ZigBee network stack and how the ZigBee network works, such that the ZigBee network module can be developed easily.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A ZigBee network module system, comprising:
a network stack, comprising a physical layer, a media access control layer, and a network layer; and
an application layer, a user application program being written into the application layer, the application layer comprising:
an application framework (AF), comprising a plurality of application objects;
a ZigBee application programming interface (API) unit, comprising a network management API and a data transmission API, the network management API having a plurality of functional instructions for executing ZigBee network functions, the data transmission API being used for transmitting data corresponding to the functional instructions; and
an application support sublayer (APS), connected to a corresponding layer of the network stack, for receiving the functional instructions of the network management API.

2. The ZigBee network module system of claim 1, wherein the functional instructions of the network management API comprise at least one functional instruction selected from the group consisting of: an starting request instruction for starting a network, a scanning request instruction for scanning a network, a joining request instruction for joining a network, a leaving request instruction for enforcing an apparatus leaving a network, an auto-searching request instruction for searching whether there is a connectable device of a network capable of providing related service, a linking instruction for a network device executing linking function, an authenticating instruction for authenticating users, and a selecting instruction for selecting a network.

3. The ZigBee network module system of claim 1, wherein the data transmission API comprises a receiving instruction for receiving data and a transmission instruction for transmitting data.

4. The ZigBee network module system of claim 1, wherein the network stack and the application layer are defined as a ZigBee module, and the user application program is embedded in the ZigBee module.

5. The ZigBee network module system of claim 1, wherein the network stack and the application layer are defined as a ZigBee module, the system further comprises an external central processing unit (CPU) connected with the ZigBee module, and the user application program is embedded in the CPU.

6. The ZigBee network module system of claim 5, wherein the CPU is connected to the ZigBee module via an interface selected from the group consisting of a universal asynchronous receiver/transmitter (UART) and an inter-integrated circuit (12C).

7. The ZigBee network module system of claim 5, wherein the CPU further comprises a user API and a firmware; the user API corresponds to the ZigBee API unit of the ZigBee module; when the user API is called, the firmware generates information which is to be transmitted to the ZigBee API unit, and the ZigBee API unit transforms the information into an interface capable of calling a corresponding layer in the network stack.

8. The ZigBee network module system of claim 1, wherein the application layer further comprises a ZigBee device object (ZDO) capable of initializing the APS, constructing information, transmitting and responding linking request, discovering devices and application services in the same network, and establishing a security relation among the devices in the network.

9. The ZigBee network module system of claim 1, wherein the physical layer of the network stack is used for starting and stopping radio receivers/transmitters, selecting channels, and transmitting and receiving packets; the media access control layer is used for managing beacons, accessing channels, managing guaranteed time slot (GTS), authenticating frames, and replying transmission, combination, and division of frames; the network layer comprises a mechanism of joining and leaving a network, a mechanism of frame security, and a mechanism of transmitting frames to a destination.

10. The ZigBee network module system of claim 6, wherein the CPU further comprises a user API and a firmware; the user API corresponds to the ZigBee API unit of the ZigBee module; when the user API is called, the firmware generates information which is to be transmitted to the ZigBee API unit, and the ZigBee API unit transforms the information into an interface capable of calling a corresponding layer in the network stack.
